(19) United States
(12) Patent Application Publication
(10) Pub. No.: US 2007/0271538 A1
(43) Pub. Date: Nov. 22, 2007

(54) Process for designing a circuit for synchronizing data asychronously exchanged between two synchronous blocks, and synchronization circuit fabricated by same

(75) Inventors: Cesar Douady, Orsay (FR); Luc Montperrus, Montigny Le Bretonneux (FR)

Correspondence Address: MEYERTONS, HOOD, KIVLIN, KOWERT & GOETZEL, P.C., P.O. BOX 398, AUSTIN, TX, 78767-0398, US

(73) Assignee: Luc Montperrus

(21) Appl. No.: 11/483,419

(22) Filed: Jul. 7, 2006

(30) Foreign Application Priority Data
May 16, 2006 (FR) FR 0604348

(51) Int. Cl. G06F 17/50

(52) U.S. Cl. 716/6

(57) ABSTRACT

The process relates to the design of a circuit for synchronizing data asynchronously exchanged between two synchronous blocks. The circuit comprises at least one critical flip-flop capable of generating a decision signal for receiving a new data value. The process furthermore comprises:
a step (20) for measuring the gain of the combinational loop of the critical flip-flop generating the decision signal for receiving a new data value;
a step (21) for estimating a metastability resolution time from the said gain and a predetermined statistical mean time between failures; and
a step (22) for adding the said resolution time to the synthesis time parameter of the said critical flip-flop or flip-flops, the said time parameter comprising the propagation time of the active edge of the clock timing signal of the receiving block, from the input of the said signal to the output of a critical flip-flop.

The present invention relates to a process for designing a circuit for synchronizing data asynchronously exchanged between two synchronous blocks, and to a synchronization circuit fabricated using such a process.

Since higher and higher frequencies are being used in current electronic systems, problems of metastability are now becoming crucial.

Conventionally, in order to reduce the problems of metastability during asynchronous transfer of data between two synchronous blocks, several flip-flops are serially connected at the input of the synchronous block receiving the data. Another possibility is to increase the gain of the combinational loops of these serial flip-flops.

Conventionally, the maximum number of transfers are only effected when the data values are stable. This means that, if a new data value to be transferred from one clock domain to another is present and stable, only one signal, called ‘decision signal’, is used.

The transfer of this decision signal from one clock domain to another may cause situations of metastability.

Moreover, this type of solution is currently reaching its limits with the new systems on silicon comprising an increasing number of critical sampling operations and high sampling frequencies.

In addition to this, no measurement of the utilization of the receiving block clock cycle is carried out, and this time may be wasted in transport times if, for example, the placement of the various flip-flops is not fine-tuned. This empirical solution is therefore no longer sufficiently reliable for the current electronic systems.

Furthermore, the settling and the hold times of the second flip-flop of the series are lost, and whole cycles of the clock timing signal of the receiving block are exclusively dedicated to the processing of the metastability, which adds problems of latency.

Accordingly, one aim of the invention is to overcome these problems, in particular to limit the presence of metastability in a circuit, and to reduce the receiving clock cycle time.

Thus, according to one aspect of the invention, there is proposed a process for designing a circuit for synchronizing data asynchronously exchanged between two synchronous blocks, the said circuit comprising at least one critical flip-flop capable of generating a decision signal for receiving a new data value. The process comprises a step for measuring the gain of the combinational loop of the critical flip-flop generating the decision signal for receiving a new data value, and a step for estimating a metastability resolution time from the said gain and a predetermined statistical mean time between failures. The process furthermore comprises a step for adding the said resolution time to the synthesis time parameter of the said critical flip-flop or flip-flops, the said time parameter comprising the propagation time of the active edge of the clock timing signal of the receiving block, from the input of the said signal to the output of a critical flip-flop.

Such a design process allows a data synchronization circuit to be obtained that is reliable at high operating frequencies of the system.

By ‘metastability of the combinational loop’ of a flip-flop is understood the capacity for a non-equilibrium state of a point of this combinational loop to subsist in a non-equilibrium state corresponding to a potential that is neither a logical 1 nor a logical 0 for a long period of time.

The transfer of the decision signal, used to indicate whether a new data value to be transferred from one clock domain to another is stable, which can lead to situations of metastability, is called a critical event. Furthermore, the first flip-flop or flip-flops that sample the said critical event in the arrival clock domain and that generate the said decision signal are designated as critical flip-flops.

Furthermore, a predetermined statistical mean time between failures of the system is guaranteed.

According to one embodiment, the said step for measuring the said gain is carried out using an electrical simulator and calculating the metastable equilibrium position of the said critical flip-flop or flip-flops, by dichotomy.

Thus, the measurement of the gain and the metastable equilibrium position are determined very precisely.

According to one embodiment, the said step for estimating the metastability resolution time comprises an analysis of the statistical distribution of the critical events generated by the said new data received, over one cycle of the clock timing signal of the receiving block, during the said predetermined statistical mean time between failures. Furthermore, the said step for estimating the metastability resolution time comprises a determination of a minimum statistical time between the said critical events and the critical sampling moment of the clock timing signal (Clk₂) of the receiving block, the said critical sampling moment being the arrival time of a data value that puts the combinational loop of the critical flip-flop into a permanent metastable state. In addition, the said estimation step comprises a conversion of the said minimum statistical time into a potential difference with the metastable equilibrium potential of the said flip-flop or flip-flops, and the use of the said potential difference and of the said gain for the estimation of the said metastability resolution time.

Thus, the said metastability resolution time can be estimated with an improved precision.

According to one embodiment, the process also comprises a step for testing the design of the said data synchronisation circuit using a transition fault model by reducing the transition time by the said resolution time.

Thus, the circuit resulting from the implementation of the process can be tested.

According to another aspect of the invention, there is also proposed a circuit for synchronizing data asynchronously exchanged between two synchronous blocks, making use of the process described hereinabove. The circuit comprises an assembly of N flip-flops capable of generating a decision signal for receiving a new data value, parallelly configured, and a multiplexer receiving the output signals from the N flip-flops of the said assembly at its input. Furthermore, the circuit comprises means for managing the N flip-flops of the said assembly and the said multiplexer, capable of controlling a cyclic sampling of the received data by the said N flip-flops, and capable of controlling the said multiplexer in such a manner that it transmits the data from one of the said N flip-flops with a shift of N-1 cycles of the clock timing signal of the receiving block.

Such a circuit allows a predetermined statistical mean time between failures of the system (MTBF) due to the metastability to be guaranteed.

According to one embodiment, the number N of the said flip-flops parallelly configured corresponds to the number of cycles of the clock timing signal of the receiving block that are necessary and sufficient in order to be greater than or equal to the metastability resolution time of the said flip-flops.

According to one embodiment, the number N of the said flip-flops parallelly configured is reduced to N=1.

Other goals, features and advantages of the invention will become apparent upon reading the following description of some non-limiting examples, which makes reference to the appended drawings, in which:

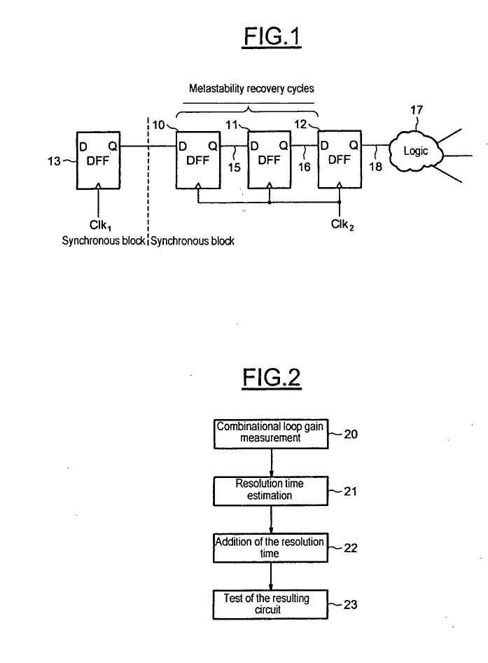

FIG. 1 illustrates a solution comprising three flip-flops serially connected;

FIG. 2 illustrates a process according to one aspect of the invention; and

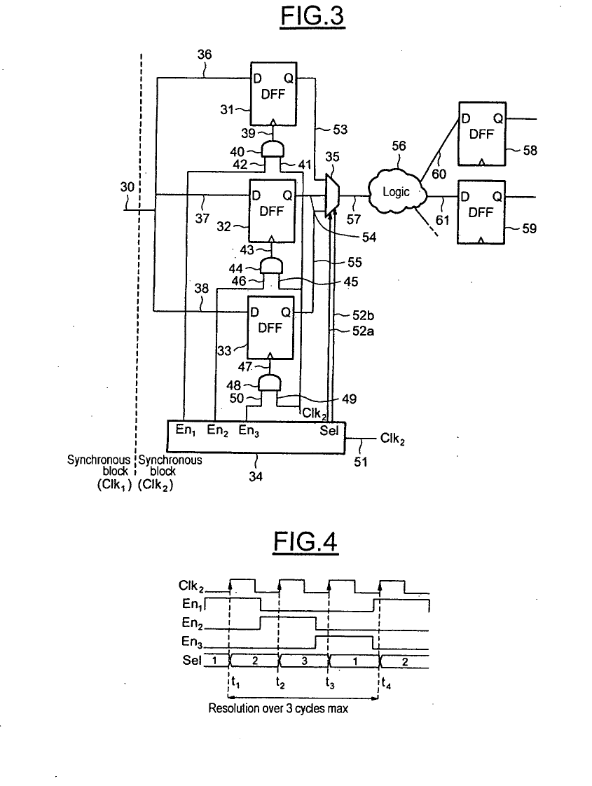

FIG. 3 illustrates a circuit designed using the process, according to one aspect of the invention.

As is illustrated in FIG. 1, one solution to the problem of metastability comprises two critical flip-flops 10, 11, with increased combinational loop gain, serially disposed within the synchronous receiving block. A third flip-flop 12, serially disposed downstream of the two critical flip-flops 10 and 11, is used to sample the stabilized decision signal output from the critical flip-flop 11.

The two flip-flops 10, 11 share the same clock timing signal Clk₂ of the receiving synchronous block.

The transmitted data come from another synchronous block comprising a flip-flop 13 for the clock timing signal Clk₁ of the synchronous transmission block.

The output of the flip-flop 13 is connected to the input of the flip-flop 10 via a connection 14, the output of the flip-flop 10 is connected to the input of the flip-flop 11 via a connection 15, and the output of the flip-flop 11 is connected to the input of the flip-flop 12 via a connection 16.

The output of the flip-flop 12 is connected to logical elements 17 via a connection 18.

In this type of circuit, several critical flip-flops in series may be required in order to generate the said decision signal, when only one is insufficient.

Such a circuit does not allow a predetermined mean time between failures to be guaranteed in the face of the high operating frequencies of the current electronic systems.

Furthermore, in such a system, no measurement of the cycle utilization of the receiving clock timing signal Clk₂ is carried out, and this time may be wasted in transport times if the placement of the various flip-flops is not fine-tuned.

The set up time and the propagation time of the active edge of the clock timing signal of the receiving block, from the input of the said signal to the output of the second critical flip-flop 11 (clock-to-output delay), are lost, and two complete cycles of the receiving clock timing signal Clk₂ are dedicated exclusively to the processing of the metastability, which does not exclude problems of latency.

The number of flip-flops is empirical and, generally, only one cycle of the receiving clock timing signal Clk₂ is dedicated to the metastability.

As is illustrated in FIG. 2, the process for designing a data synchronization circuit according to one aspect of the invention comprises a step 20 for measuring the gain of the combinational loop of the flip-flop generating the decision signal for receiving a new data value.

A flip-flop with a high gain is chosen, or, if the standard library used comprises a flip-flop dedicated to the metastability, this flip-flop with high gain is used.

Using an electrical simulator, the metastable equilibrium potential is determined, at a point of the combinational loop, under the required temperature and power supply conditions, by successive approximations based on a dichotomy approach with the maximum possible precision.

One flip-flop, denoted ‘master-slave’, comprises two combinational loops respectively associated with the master part and the slave part. The combinational loop of interest in the present invention is the combinational loop associated with the master part, since this samples the data originating from the clock domain of the transmission block.

Above the equilibrium potential, the flip-flop behaves in such a manner as to reach one of the two stable states of the flip-flop, and below this equilibrium potential, the flip-flop behaves in the opposite manner, raching the other stable state of the flip-flop.

The closer the system comes to the metastable equilibrium position, the longer the flip-flop takes to return to an equilibrium position.

The critical sampling moment is not the moment of the active transition of the clock timing signal, but the arrival time of a data value which would theoretically put the flip-flop into its metastable position permanently.

When the precision limit supported by the simulator algorithms and the flip-flop component models is reached, the gain of the combinational loop can be measured and it can be verified that it is constant within the linear region, in other words in the region where the potential follows an exponential curve.

Subsequently, during a step 21, a metastability resolution time is estimated from the gain determined for the combinational loop and from a predetermined mean time between failures.

A predetermined statistical MTBF (Mean Time Between Failures) is chosen that is reasonable. The statistical MTBF of the system is the statistical mean of the times between two successive failures of the system, and it defines a reference period for which the number of critical events is determined as a function of the data transmission frequency. Subsequently, the distribution of these events over time during the receiving clock timing signal period is studied.

Generally speaking, the assumption of a uniform distribution of the events is reasonable. However, in some cases, although the clock timing signals are asynchronous relative to one another, they may exhibit beating phenomena caused, for example, by coupling of the clock timing signal generators through their power supplies.

Once the statistical distribution model has been established, the minimum statistical time difference between an event and the critical sampling moment, for a fixed mean time between failures, is deduced from this.

For a given distribution, the greater the number of events, the closer an event can statistically come to the critical position.

In other words, the probability that an event will arrive separated from the critical sampling moment by a duration less than this minimum time difference is, on average, once over the duration corresponding to the predetermined mean time between failures or MTBF.

Then, the time difference relative to the critical sampling moment is transformed into a difference of potentials relative to the metastable equilibrium potential, by using the slope of the flip-flop internal signal that imposes the potential on the input point of the decision-taking combinational loop when a new data value arrives.

The following equation is used:

$$K = \frac{ln ( \frac{\vert {V}_{s} - {V}_{eq} \vert}{\vert {V}_{init} - {V}_{eq} \vert} )}{{T}_{res}}$$

in which:
K is the previously measured gain of the combinational loop;
Vₛ is a threshold potential, beyond which it is considered that the logical state of the signal may be propagated safely, for example expressed in Volts;
Vᵢₙᵢₜ is the potential at the moment of sampling, for example expressed in Volts;
V_{eq} is the metastable equilibrium potential, for example expressed in Volts; and
Tᵣₑₛ is the resolution time of the synchronization circuit, for example expressed in s.

From this equation, the resolution time Tᵣₑₛ is deduced, which should not, statistically speaking, be exceeded more than once over the predetermined mean time between failures, and which the synchronization circuit must support.

A constraint in the form of a predetermined mean time between failures has therefore been transformed into a penalty delay or additional time delay for the critical flip-flop in question.

Accordingly, the estimated resolution time is added to the timing constraints taken into account by the circuit synthesis tool, during a step 22. Thus, in the case where the resolution time Tᵣₑₛ is less than the cycle time of the receiving clock timing signal, the whole cycle behind the decision combinational loop need no longer be dedicated to the metastability. If there is time left, it may be safely used for other logical operations.

Thus, conventional synthesis tools can be used for performing an optimisation of the synchronization device that takes into account the predetermined statistical mean time between failures of the system MTBF constraint in relation to the metastability problem. Similarly, the circuit thus obtained may be validated by conventional statistic timing analysis tools.

Furthermore, the circuit obtained can be tested in production after fabrication, during a step 23, with a ‘transition fault’ model. It is thus possible to perform real-speed functional tests of the synchronization circuit. The cycle time for a full-speed transition between two flip-flop assemblies is indicated to the test tool, without being able to reproduce on the test tool a metastable state in the critical flip-flops, but by decreasing the transition time by an amount equal to the resolution time.

It can therefore be validated that the synchronization circuit fabricated meets the metastability performance requirements specified by the mean time between failures.

FIG. 3 illustrates a circuit for synchronizing data asynchronously exchanged between two synchronous blocks, designed using the process previously described.

A link 30 allows data to be transferred from a first synchronous block with clock timing signal Clk₁ to a second synchronous block, with clock timing signal Clk₂.

Three flip-flops 31, 32 and 33, capable of generating a decision signal for receiving a new data value, are parallelly configured.

The circuit also comprises means 34 for managing the three flip-flops 31, 32 and 33, parallelly configured, and a multiplexer 35.

The connection 30 is separated into three connections 36, 37 and 38, respectively leading to the flip-flops 31, 32 and 33.

The clock timing signal of the flip-flop 31 is delivered by the output 39 of an AND logical gate 40 receiving the clock timing signal Clk₂ of the receiving block at its input, via a connection 41, and a validation signal En₁, via a connection 42.

The flip-flop 32 receives a clock timing signal via an output 43 of an AND logical gate 44 receiving the clock timing signal Clk₂ of the receiving block at its input via a connection 45, and a validation signal En₂ via a connection 46.

The flip-flop 33 receives a clock timing signal via an output 47 of an AND logical gate 48 receiving the clock timing signal Clk₂ of the receiving block at its input, via a connection 49, and a validation signal En₃ via a connection 50.

The validation signals En₁, En₂ and En₃ are generated by the management means 34.

The management means 34 receive the clock timing signal Clk₂ via a connection 51, and deliver selection signals Sel to the multiplexer 35, via two connections 52a and 52b, allowing the active input of the multiplexer 35 to be selected.

Since the multiplexer 35 has three inputs, the selection can be coded over only two bits of information, and can therefore be transmitted via two connections 52a and 52b.

The multiplexer 35 receives the respective outputs 53, 54 and 55 from the flip-flops 31, 32 and 33 at its input.

The multiplexer 35 is connected at its output to an assembly 56 of logical elements via a connection 57.

The assembly 56 of logical elements is connected, via respective connections 60 and 61, to two flip-flops 58 and 59.

Thus, in this synchronization circuit, each of the flip-flops parallelly connected samples in turn the data coming from the transmission synchronous block.

It goes without saying that any number N of flip-flops may be parallelly configured, depending on the system specifications, but the example illustrated contains three of them.

It therefore takes N cycles of the clock timing signal Clk₂ of the receiving block for a metastability problem, if any, to be resolved.

The result of the decision-taking combinational loop is only exploited after several cycles of the clock timing signal Clk₂, as illustrated in FIG. 4.

Indeed, as is illustrated by the timing diagrams in FIG. 4, the clock timing signal Clk₂ of the receiving block comprises successive sampling edges corresponding to successive times t₁, t₂, t₃ and t₄.

At time t₁, the validation signal En₁ activates the sampling of data by the flip-flop 31, and the validation signals En₂ and En₃ deactivate the sampling of data by the flip-flops 32 and 33. Thus, a data value arriving at the connection 30 is sampled by the flip-flop 31 at time t₁.

At time t₂, the validation signal En₂ activates the sampling of data by the flip-flop 32, and the validation signals En₁ and En₃ deactivate the sampling of data by the flip-flops 31 and 33. Thus, a data value arriving at the connection 30 is sampled by the flip-flop 32 at time t₂.

At time t₃, the validation signal En₃ activates the sampling of data by the flip-flop 33, and the validation signals En₁ and En₂ deactivate the sampling of data by the flip-flops 31 and 32. Thus, a data value arriving at the connection 30 is sampled by the flip-flop 33 at time t₃.

At time t₄, like at time t₁, the validation signal En₁ activates the sampling of data by the flip-flop 31, and the validation signals En₂ and En₃ deactivate the sampling of data by the flip-flops 32 and 33. Thus, a data value arriving at the connection 30 is sampled by the flip-flop 31 at time t₄.

The selection signals Sel, at the beginning of the third cycle of the clock timing signal Clk₂ of the receiving block, starting at time t₃ and terminating at time t₄, positions the multiplexer 35 such that the following flip-flops 58, 59 receive the output from the flip-flop 31.

These flip-flops 58, 59 sample the data at the beginning of the following cycle, the fourth, starting at time t₁.

The selection Sel of the multiplexer 35 follows that of the sampling flip-flops 31, 32 and 33 by the validation signals En₁, En₂ and En₃.

The system therefore has 3 cycles of the clock timing signal Clk₂ of the receiving block in order to solve a metastability problem, if any, of the combinational loop of the critical flip-flop that has sampled the data.

The expected number of cycles for optimising the synchronization circuit is equal to the number of flip-flops N in parallel decremented by 1, in such a manner that, between the moment when the data value is sampled by the flip-flop generating a decision signal for receiving a new data value and the moment when it will be sampled again by any given flip-flop, there occurs a number of cycles equal to the number of flip-flops parallelly configured.

If the resolution time Tᵣₑₛ is in the range between N-1 cycles and N cycles of the receiving clock timing signal Clk₂, the unused time could be dedicated to logical, such as is represented by the assembly 56. FIG. 4 illustrates this for the circuit in FIG. 3, for which N=3.

During the synthesis, paths that run from the parallel-configured flip-flops 31, 32 and 33 to the following flip-flops 58 and 59 are declared as multicycle paths over n-cycles.

1. Process for designing a circuit for synchronizing data asynchronously exchanged between two synchronous blocks, the said circuit comprising at least one critical flip-flop capable of generating a decision signal for receiving a new data value, the process comprising:
measuring the gain of the combinational loop of the critical flip-flop generating the decision signal for receiving a new data value;
estimating a metastability resolution time from the said gain and a predetermined statistical mean time between failures; and
adding the said resolution time to the synthesis time parameter of the said critical flip-flop or flip-flops, the said time parameter comprising the propagation time of the active edge of the clock timing signal of the receiving block, from the input of the said signal to the output of a critical flip-flop.

2. Process according to claim 1, wherein measuring the said gain is carried out using an electrical simulator and calculating the metastable equilibrium position of the said critical flip-flop or flip-flops, by dichotomy.

3. Process according to claim 1, wherein estimating the metastability resolution time comprises:
analyzing the statistical distribution of the critical events generated by the said new data received, over one cycle of the clock timing signal of the receiving block, during the said predetermined statistical mean time between failures;
determining a minimum statistical time between the said critical events and the critical sampling moment of the clock timing signal of the receiving block, the said critical sampling moment being the arrival time of a data value that puts the combinational loop of the critical flip-flop into a permanent metastable state;
converting the said minimum statistical time into a potential difference with the metastable equilibrium potential of the said flip-flop or flip-flops; and
using the said potential difference and of the said gain for the estimation of the said metastability resolution time.

4. Process according to claim 1, further comprising testing the design of the said data synchronisation circuit using a transition fault model by reducing the transition time by the said resolution time (Tᵣₑₛ).

5. Circuit for synchronizing data asynchronously exchanged between two synchronous blocks, comprising:
an assembly of N flip-flops capable of generating a decision signal for receiving a new data value and parallelly configured;
a multiplexer receiving the output signals from the N flip-flops of the said assembly at its input; and
means for managing the N flip-flops of the said assembly and of the said multiplexer, capable of controlling a cyclic sampling of the received data by the said N flip-flops, and capable of controlling the said multiplexer in such a manner that it transmits the data from one of the said N flip-flops with a shift of N-1 cycles of the clock timing signal of the receiving block.

6. Circuit according to claim 5, wherein the number N of the said flip-flops parallelly configured corresponds to the number of cycles of the clock timing signal of the receiving block that are necessary and sufficient in order to be greater than or equal to the metastability resolution time of the said flip-flops.

7. Circuit according to claim 5, wherein the number N of the said flip-flops parallelly configured is reduced to N=1.
